(19) United States
(12) Patent Application Publication
(10) Pub. No.: US 2026/0005490 A1
(43) Pub. Date: Jan. 1, 2026

(54) DISCRETE PULSE CONTROL FOR PHASE RANDOMIZATION APPLICATIONS

(71) Applicant: HEQA SECURITY LTD, Modi’in- Maccabim-Re'ut (IL)

(72) Inventors: Nitzan LIVNEH, Mevasseret Zion (IL); Hagai EISENBERG, Jerusalem (IL); Yehuda PILNYAK, Tel-Aviv (IL); Pinhas ROSENFELDER, Bet Shemesh (IL)

(73) Assignee: HEQA SECURITY LTD, Modi’in- Maccabim-Re'ut (IL)

(21) Appl. No.: 18/704,321

(22) PCT Filed: Oct. 26, 2022
(86) PCT No.: PCT/IL2022/051129

§ 371 Date: Apr. 24, 2024

Related U.S. Application Data
(60) Provisional application No. 63/271,929, filed on Oct. 26, 2021.

(51) Int. Cl. H01S 5/042; G05B 15/02; H01S 5/12

(52) U.S. Cl. CPC H01S 5/0427; G05B 15/02; H01S 5/12

(57) ABSTRACT

Techniques for controlling light/radiation emitted from a laser light source are disclosed, wherein electric supply signals of a laser light source are modulated for generating a plurality of fixed predefined working supply signals configured to drive the laser light source during time intervals in which the light/radiation thereby emitted is encoded with data, mid variable idle supply signals for driving the laser light source between the data encoding time intervals. The modulating comprises at least one of generating the idle supply signals to include random time intervals and fixed idle supply signal level/intensity greater than a lasing threshold of said laser light source, and/or generating the idle supply signals to include idle supply signals having random levels/intensities or randomly alternated levels/intensitics greater than a lasing threshold of said laser light source, to thereby affect random phase changes between said data encoding time intervals without reducing the supply signal below said lasing threshold.

### TECHNOLOGICAL FIELD

The present invention is generally in the field of optical communication systems, particularly in applications requiring phase randomization, such as used in quantum key distribution (QKD) systems.

### BACKGROUND ART

References considered to be relevant as background to the presently disclosed subject matter are listed below:
C. H. Bennett and G. Brassard, “Quantum cryptography: public key distribution and coin tossing,” in Proceedings of the International Conference on Computers, Systems & Signal Processing, Bangalore, India, pp. 175-179 (1984).
H. K. Lo, and J. Preskill, “Phase randomization improves the security of quantum key distribution”, preprint quant-ph/0504209 (2005).
P. Hiskett, G. Bonfrate, G. Buller and J. Townsend, “Eighty kilometre transmission experiment using InGaAs/InP SPAD-based quantum cryptography receiver operating at 1.55 m”, Mod. Opt. 48, 1957 (2001).
Z. Cao, Z. Zhang, H.-K. Lo and X. Ma, “Discrete-phase-randomized coherent state source and its application in quantum key distribution”, New J. Phys. 17, 053014 (2015).
H.-K. Lo, X. Ma and K. Chen, “Decoy state quantum key distribution”, Phys. Rev. Lett. 94, 230504 (2005).

### BACKGROUND

This section intends to provide background information concerning the present application, which is not necessarily prior art.

Quantum key distribution (QKD) protocols, such as BB84 [1], rely on single-photon sources as their qubit resource. However, as single-photon sources still remain a challenge, many QKD systems are based on weak coherent laser pulses as their photon source.

While it was proven that weak coherent laser pulses can function as reliable qubits under certain conditions, the coherence itself imposes a problem, as the existence of a possible attack has been proven to eliminate the security of the system [2], where the coherence between pulses is used to extract information on the qubit value.

To this end, a common solution to defend against such coherent attacks is by ensuring phase randomization between sequences of transmitted pulses, to thereby prevent acquisition of information by an eavesdropper, as there is no known phase relation between consecutive sequences of the transmitted pulses.

In order to achieve phase randomization, two main methods are commonly employed. The first introduces a phase modulator after the laser light source of the transmitter. The phase modulator is activated for each sequence of transmitted pulses with a random voltage, to thereby set a random phase shift between the consecutive sequences of the transmitted pulses. The second method relics on the physical nature of semiconductor lasers, where the laser drive current (also referred to herein as injection current I) is typically directly modulated by an external electrical pulse generator. By setting the electrical injection current I of such semiconductor lasers to values that oscillate between an electrical current level I=I₀ lower than the laser threshold current I₀<Iₜₕ, and the laser's operational/working electrical current level I=I₁ to values greater than the laser threshold current I₁>Iₜₕ, the laser source is repeatedly gain-switched between ‘ON’ and ‘OFF’ states to operate in a (I/O) mode. This way, when the laser source is in the ‘OFF’ state (i.e., I₀<Iₜₕ. before stimulated light emission commences) for sufficient time intervals, the cavity of the laser source is cleared out of photons, and the next ‘ON’ state (i.e., I₁>Iₜₕ) relies on amplification from the spontaneous emission, which has no phase relation to the previous pulse. Thus, phase randomization is achieved [3].

While these methods ensure phase randomization, it was proven that for QKD purposes it is sufficient to perform discrete phase randomization. Unlike the required infinite resolution phase shift or physical randomization of gain-switching, discrete phase randomization requires a minimal number of random phase values—N=4 without the use of decoy states protocol, or N=10 [4] for implementations that utilize decoy state QKD protocol. The QKD secure bit rate without utilization of decoy states is much lower [5] due to the use of weak laser signals, and therefore the use of decoy state QKD e.g., with ten (10) or more phase values, is preferred, as it permits utilization of stronger laser signals resulting in higher secure bit rates.

Phase randomization techniques used nowadays require either the addition of a phase modulator, which increases costs and complexity of the system, or utilizing gain/intensity switching circuitries, which may result in unwanted noise-related effects (e.g., power and/or wavelength instability, and/or switching rate limits), introduced due to the repeated ‘ON/OFF’ switching of the laser light source.

US Patent Publication No. 2017/237505 discloses a transmitter for a continuous variable quantum communication system, the transmitter comprising: a coherent light source; a first controller, configured to apply a first signal to said coherent light source such that said coherent light source generates coherent light; a phase control element, configured to apply perturbations to said first signal, each perturbation producing a phase shift between parts of the generated coherent light; a first optical component, configured to produce optical intensity modulation, wherein said coherent light source is configured to supply said generated light to said optical component; a second controller, configured to apply a second signal to said optical component such that a light pulse is emitted during a period of time that a first part of the generated light is received, and a light pulse is emitted during a period of time that a second part of the generated light is received; an intensity control element, configured to modulate the amplitude of an emitted light pulse; wherein the phase control element and the intensity control element are configured to encode information in a continuum of values of the phase and amplitude of an emitted light pulse.

### General Description

The present application provides systems and methods for discrete phase randomization without the additional need of phase modulators, and without using any gain switching means. The discrete phase randomization techniques disclosed herein employ direct phase modulation by switching power supply signals driving a laser light source between a working and idle supply levels that are maintained above the lasing threshold Iₜₕ of the laser light above for the modulation, thus minimizing or eliminating the aforementioned drawbacks of the conventional solutions. In this way, by guaranteeing that the working and idle supply signal levels driving the laser light source are always greater than the lasing threshold of the laser light source, the relaxation oscillations and the turn-on delays between consecutive transmission time intervals/gaps are avoided.

In a broad aspect the present disclosure provides a system and method for effecting random phase changes between working regimes of data transmission pulses of an optical transmitter system by randomly altering time intervals (τⱼ) between the working regimes while generating a constant idle supply signal power level (e.g., idle electric supply/injection currents I₀) driving the laser light source, and/or by randomly altering powers/levels of the idle supply signals e.g., while maintaining a constant time interval (τ) between the working regimes. During the working regimes time intervals in which the (e.g., QKD) data transmission pulses are produced, the laser light source is driven by a constant/fixed working supply signal (e.g., working electric supply/injection current I₁) guaranteeing continuous and uninterrupted emission of laser light in a desired stable wavelength and phase.

The term working supply signal as used herein refers to an electric supply/injection current (or voltage) driving the laser light source during the working regimes time intervals in which the data transmission pulses are produced. The working supply signals thus have sufficient power/level to guarantee continuous uninterrupted emission of laser light by the laser light source in a desired stable wavelength and phase for encoding data thereinto to produce the data transmission pulses. It is noted that working supply signal is not encoded with data itself, but rather used to generate the optical signal that will later be encoded with data e.g., by an electro-optical modulator.

The term idle supply signal as used herein refers to an electric supply/injection current (or voltage) driving the laser light source between the working regimes time intervals and configured for lasing at a wavelength that is different from the wavelength lased in the working regime. The powers/levels of the idle supply signals are configured to provide continuous stimulated emission of laser light by the laser light source with wavelengths that are either varying in time or different from the wavelength of the laser light generated by the laser light source during the working the regimes for at least part of the time interval between the consecutive working regimes.

In the embodiments disclosed herein, the working supply signal (I₁) driving the laser light source during the working regimes, and the idle supply signal (I₀) driving the laser light source between the working regimes are always greater than the lasing threshold (Iₜₕ) of the laser light source (i.e., I₀>Iₜₕ and I₁>Iₜₕ). It is however noted that while the power/level of the working supply signal (I₁) is generally fixed and stable, the idle supply signal (I₀) can assume powers/levels that can be either smaller of greater than the power/level of the working supply signal (I₁).

In some embodiments the 2π phase range is divided into a predefined number (N) of phase segments from which a phase change between the transmission pulses is randomly selected for each idle supply signal driving the laser light source between the working regimes. A random number generator/algorithm (generally referred to herein as RNG) can be used to randomly select a phase segment from the N phase segments for each idle supply signal driving the laser light source between the working regimes.

Optionally, but in some embodiments preferably, a signal generator is used to controllably generate electric supply pulse signals for driving the laser light source and defining the time intervals during which the working and the idle supply signals are thereby generated. These working and/or idle time intervals as defined by the signal generator, and/or their powers/levels, can be controllably adjusted by application of suitable control signals to the signal generator. Accordingly, the signal generator can be provided with control signals for causing it to alter the time intervals (τⱼ) between the working regimes and produce a constant predefined idle supply signal in these time intervals, so as to cause a phase change within a phase segment randomly selected using the RNG i.e., the duration of the time intervals (τⱼ) between working regimes is set according to random numbers generated by the RNG.

Alternatively, or additionally, the signal generator can be provided with control signals for causing it to set a constant predefined time interval between the working regimes and alter the idle supply signals driving the laser light source in these time intervals, so as to cause a phase change within a phase segment randomly selected using the random number generator i.e., the level/power of the idle supply signals

$$( {I}_{0}^{j} )$$

driving the laser light source between the working regimes is set according to random numbers generated by the RNG.

The idle supply signals driving the laser light source between the working regimes can be generated by a discrete signal level generator utilizing analog combiners and controllably switched input signals. The discrete signal level generator can use one or more input analog combiners which input terminals are electrically coupled via controllable selectors/switches to two or more different voltage levels (e.g., “0” and Vi, where i in an indexing integer number) configured to select the voltage input levels of each of their input terminals to be thereby combined/summated, and one or more output analog combiners configured to combine/summate the output signals generated by the one or more input analog combiners and produce a desired output voltage signal for driving laser light source.

In some embodiments the idle supply signal is modulated by a noise source (e.g., type of semiconductor avalanche noise generator). A processor (e.g., a PC comparator) can be used to modulate the idle supply signals with the noise signals generated by the noise source, and thereby cause random phase changes between the working regimes.

In one aspect there is provided a control system for controlling light/radiation emitted from a laser light source, the system comprising a signal generator configured to controllably generate supply signals driving the laser light source and a control unit configured to generate control signals for controlling the operation of the signal generator for thereby generating a fixed predefined working supply signal driving the laser light source during time intervals in which the light/radiation thereby emitted is usable for data encoding, and variable idle supply signals driving the laser light source between the data encoding time intervals. The control signals configured to cause generation of the idle supply signals having at least one of the following: random time intervals and fixed idle supply signal level/intensity greater than a lasing threshold of said laser light source; and/or idle supply signal having random levels/intensities or randomly alternated levels/intensities greater than a lasing threshold of the laser light source, to thereby affect random phase changes between the data encoding time intervals without reducing the supply signal below the lasing threshold.

The control unit can be configured to divide a phase range with the system into a predetermined number of phase segments, randomly select for each of the idle supply signals one of the predetermined number of phase segments, and generate the control signals such that the phase change affected by each of the idle supply signals is within the respective phase segment randomly therefor. The control unit can be configured to modulate the idle supply signal in accordance with a binary state/signal randomly selected from a number of possible phase segments.

The control system comprises in some embodiments a random number generator (RNG), or a pseudo-RNG. The control unit can according configured to use random numbers generated by the RNG or the pseudo-RNG for the selection of phase segments for the idle supply signals. For example, the predetermined number of phase segments is set to four (4) in possible embodiments. In other possible embodiments the predetermined number of phase segments is set to ten (10), or greater than ten.

The control system comprises in some embodiments a discrete signal level generator configured to generate the idle supply signal by an analog combiners arrangement having controllably switched input signals. The control unit can be configured to generate control signals for setting the controllably switched input signals in order to output a desired idle supply signal by the analog combiners.

The control system comprises in some embodiments a noise source configured to cause generation of the idle supply signals having randomly alternating signal levels. The system can be configured to cause generation of the idle supply signals having random signal length and time spacing. In other possible embodiments the control system is configured to cause generation of the idle supply signals having random signal length and time spacing and two discrete laser current drive levels.

A comparator can be used to toggle between HIGH and LOW states thereof responsive to signals generated by the noise source. Optionally, a pulse signal source is used to hold the comparator in its HIGH states for time durations required for generating the fixed predefined working supply signal of the laser light source. An analog combiner can be used to sum the signals from the noise source and the pulse signal source and drive an input terminal of the comparator. In possible embodiment the pulse signal source is configured to drive a latch input of the comparator.

The laser light source can be configured to generate laser light/radiation for QKD data encoding. The control system can be configured to generated synchronization signals indicative of working time intervals in which the fixed predefined working supply signals are generated.

In another aspect there is provided a quantum communication transmitter comprising the control system of any one of the embodiments disclosed herein and an electro-optical modulator configured to encode data into the light/radiation emitted by laser light source during working time intervals in which the fixed predefined working supply signals are generated. The quantum communication transmitter can be configured to receive synchronization signals generated by the control system to indicate the working time intervals in which the fixed predefined working supply signals are generated, and encode the data by the electro-optical modulator based thereon.

In yet another aspect there is provided a method for controlling light/radiation emitted from a laser light source for data communication, the method comprising modulating electric supply signals of a laser light source for generating a plurality of fixed predefined working supply signals configured to drive said laser light source during time intervals in which the light/radiation thereby emitted is encoded with data, and variable idle supply signals for driving said laser light source between the data encoding time intervals. The modulating comprises at least one of the following: generating the idle supply signals to include random time intervals and fixed idle supply signal level/intensity greater than a lasing threshold of the laser light source; and/or generating the idle supply signals to include idle supply signals having random levels/intensities or randomly alternated levels/intensities greater than a lasing threshold of the laser light source, to thereby affect random phase changes between the data encoding time intervals without reducing the supply signal below the lasing threshold.

The comprises in some embodiments dividing a phase range into a predetermined number of phase segments, randomly selecting for each of the idle supply signals one of the predetermined number of phase segments, and generating the control signals such that the phase change affected by each of the idle supply signals is within the respective phase segment randomly therefor. The generating of the idle supply signal can comprise controllably selecting one or more analog signals and combining them together to provide a desired idle supply signal.

The method comprises in some embodiments generating a noise signal and generating the idle supply by randomly alternating levels of a supply signal in manner corresponding to said noise signal. The method can comprise toggling a comparator between HIGH and LOW states thereof in manner corresponding to the noise signal. The method can further comprise latching the comparator with a pulse signal configured to define data encoding time intervals.

In possible application the method comprises generating synchronization signals indicative of working time intervals in which the fixed predefined working supply signals are generated. In possible applications the method comprises encoding quantum bit states into the light/radiation emitted by the laser light source during the data encoding time intervals. Optionally, but in some embodiments preferably, the method comprises encoding QKD data into the light/radiation emitted by the laser light source during the data encoding time intervals.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIGS. 1A and 1B graphically illustrate laser's power supply modulation signals usable for phase randomization according to some embodiments (the depicted currents are normalized with respect to lasing threshold current Iₜₕ), wherein FIG. 1A demonstrates use of variable time-intervals (also referred to herein as variable gap-widths) between consecutive working regimes for the phase randomization, and FIG. 1B demonstrates use of variable injection-currents (also referred to herein as variable gap-depths) between consecutive working regimes for the phase randomization;

FIGS. 2A to 2C schematically illustrate randomized-phase pulse generating systems according to possible embodiments, wherein FIG. 2A shows a block diagram and graphical illustration demonstrating a variable time-interval based control scheme, FIG. 2B shows a block diagram and graphical illustration demonstrating a variable injection-current based control scheme, and FIG. 2C demonstrates division of the phase range into a predefined number of phase regions;

FIGS. 3A and 3B respectively graphically illustrate pulse width phase dependence and oscillating interference intensity between consecutive working regimes, according to possible embodiments;

FIGS. 4A and 4B schematically illustrate voltages generation schemes according to possible embodiments, wherein FIG. 4A is a block diagram demonstrating generation of up to 16 voltage levels from four (4) possible input voltage levels and FIG. 4B is a block diagram showing a numeric example of generating a specific voltage level (one (1) of sixteen (16) possible voltage levels);

FIGS. 5 and 6 are block diagrams schematically illustrating optical pulse generation system according to possible embodiments utilizing noise source for causing random phase changes between consecutive working regimes; and

FIG. 7 schematically illustrates possible states modulation signals for the idle supply signal according to possible embodiments.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Emphasis instead being placed upon clearly illustrating the principles of the invention such that persons skilled in the art will be able to make and use the phase randomization, once they understand the principles of the subject matter disclosed herein. This invention may be provided in other specific forms and embodiments without departing from the essential characteristics described herein.

The present disclosure provides techniques for applying random phase changes between working regimes of data transmission pulses of an optical transmitter by randomly altering time intervals/gaps between the working regimes while driving the laser light source of the transmitter with a fixed predefined idle supply signal, and/or by driving the laser light source with a randomly changing idle supply signals between the working regimes.

During the time intervals of the working regimes a working supply signal is used to drive the laser light source with a supply power/level guaranteeing continuous uninterrupted emission of laser light in a desired stable wavelength and phase. On the other hand, the idle supply signal is configured to guarantee continuous stimulated lasing by the laser light source, but with a wavelength that is either different from the wavelength of laser light produced during the working regimes, or changing over time within the time interval between the working regimes. The powers/levels of the working and idle supply signals are configured to always remain above/greater than the lasing threshold of the laser light source, so as to guarantee continuous stimulated emission of laser light throughput the operation of the optical transmitter.

For an overview of several example features, process stages, and principles of the invention, the examples of phase randomization techniques illustrated schematically and diagrammatically in the figures are intended for QKD systems. These QKD systems are shown as one example implementation that demonstrates a number of features, processes, and principles used to provide secure QKD protocol implementations, but they are also useful for other applications and can be implemented in different variations. Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in optical communication applications may be suitably employed, and are intended to fall within the scope of this disclosure.

In embodiments disclosed herein an electric injection current modulation pattern having a working regime defined by application of a working injection current signal I₁, that is greater than the lasing threshold current Iₜₕ (i.e., I₁>Iₜₕ, wherein the lasing threshold current is the lowest electrical current guaranteeing stimulated emission by the laser light source), and a phase determining regime defined by application of an idle injection current I₀, that is also greater than the lasing threshold current Iₜₕ (i.e., I₀>Iₜₕ), wherein I₀≠I₁. The use of such working/idle injection current signal modulation patterns in embodiments of the present application is different from the conventional gain switching techniques, wherein the modulation of the power supplied of the laser light source involves electric currents that are smaller than the lasing threshold current Iₜₕ of the light source i.e., I₀<Iₜₕ.

The wavelength λ of the light/radiation produced by the laser light source is dependent on the working injection current I₁ and the idle injection current I₀, in accordance with the wavelength current coefficient relationship

$$\frac{Δλ}{Δ I} = const e . g . ,$$

with a value of

$$\frac{Δλ}{Δ I} = 10 \frac{pm}{mA}$$

for some distributed-feedback laser (DFB) lasers. Accordingly, different injection currents I_{0/1}ⁱ result in emission of light/radiation in different wavelengths λᵢ.

For a given time interval τⱼ between consecutive pulse sequences different wavelengths propagate in different numbers i.e., for a wavelength

$${λ}_{i} ( {I}_{0 / 1}^{i} )$$

the number of waves nₖ obtained during a time interval τⱼ between consecutive pulse sequences is

$${n}_{k} = \frac{c {τ}_{j}}{n {λ}_{i}} ,$$

where c is the speed of light in vacuum and n is the refractive index of the medium in which the light propagates. As such, the number of waves nₖ is not necessarily a whole number. A phase difference ϕₖ=2π(nₖ−nₖ_{₂}) thus occurs between consecutive pulse sequences when there is a difference in the number of wavelengths nₖ_{₁} and nₖ_{₂} produced between consecutive working regimes of laser light pulse sequences.

From the definition of the number of waves nₖ, it is clear that the value of the phase lag ϕₖ between consecutive pulse sequences can be controlled by either changing the wavelength λᵢ of the emitted light/radiation e.g., by modulating the injection current supplied to the laser light source, changing the durations of the time intervals τⱼ between working regimes of consecutive laser light pulse sequences, or by changing both the wavelength λᵢ and the durations of the time intervals τⱼ between the working regimes of consecutive laser light pulse sequences.

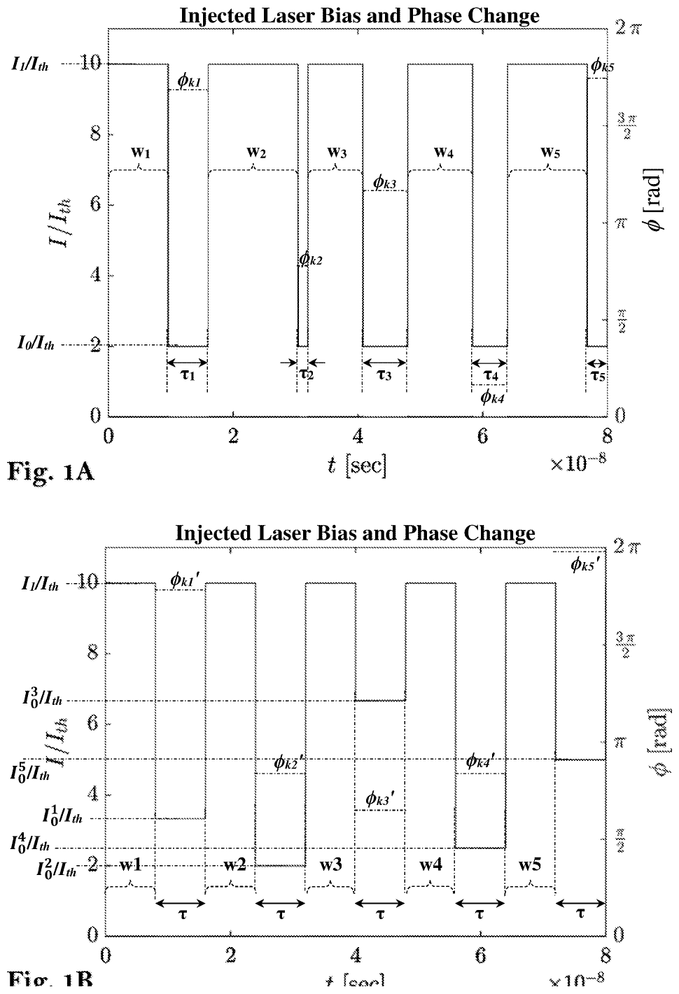

An example of changing these two parameters to control the relative phase between data transmission time slots of the working regimes is illustrated in FIGS. 1A and 1B. For example, the time intervals of interest can be the working time slots/intervals of data encoding referenced in FIGS. 1A and 1B by w1, w2, w3, . . . . The phase control between consecutive laser light (e.g., QKD data transmission) pulse sequences is achieved in some embodiments, as exemplified in FIG. 1A, by controlling the duration of the time intervals τⱼ (τ₁, τ₂, τ₃, . . . ) between the application of the working injection currents I₁ i.e., the electric injection current applied during the working regimes w1, w2, w3, . . . in which data is encoded and transmitted. As exemplified in FIG. 1A, for each time interval τ₁, τ₂, τ₃, . . . a respective varying phase lag ϕₖ₁, ϕₖ₂, ϕₖ₃ . . . is caused so as to affect a phase difference between the working regimes, and the electric current supplied to the laser light source during its operation is always greater than the lasing current Iₜₕ of the laser the light source.

Alternatively, or additionally, the phase control between consecutive pulse sequences can be achieved in some embodiments, as exemplified in FIG. 1B, by supplying variable idle injection currents

$${I}_{0}^{j}$$

(depth) to the laser light source between the consecutive working regimes

$$( i . e . , {I}_{0}^{1}$$

between the working regimes w1 and w2,

$${I}_{0}^{2}$$

between the working regimes w2 and w3, . . . and so on), thus changing the wavelength λⱼ of the laser light/radiation emitted between the consecutive working regimes w1, w2, w3, . . . . As exemplified in FIG. 1B, for each idle injection current

$${I}_{0}^{1} , {I}_{0}^{2} , {I}_{0}^{3} , … ,$$

a respective phase lag ϕₖ₁′, ϕₖ₂′, ϕₖ₃′, . . . is caused to obtain the desired phase differences, and a fixed time interval/gap τ is maintained between the consecutive working regimes w1, w2, w3, . . .

Accordingly, by controlling the durations of the time intervals τⱼ between the consecutive working regimes w1, w2, w3, . . . and/or the depths/levels of the idle supply signals

$${I}_{0}^{j}$$

driving the laser light source during the time intervals τⱼ between these working regimes, one can set any arbitrary phase difference ϕₖⱼ between the consecutive working regimes w1, w2, w3, . . . , as demonstrated in FIGS. 1A and 1B.

To fulfil the phase randomization protocol of the present application, in some embodiments the 2π phase range is divided into N equally distributed phase values,

$${ϕ}_{kj} = \frac{2 π j}{N} , j ∈ [ 0 , N - 1 ] .$$

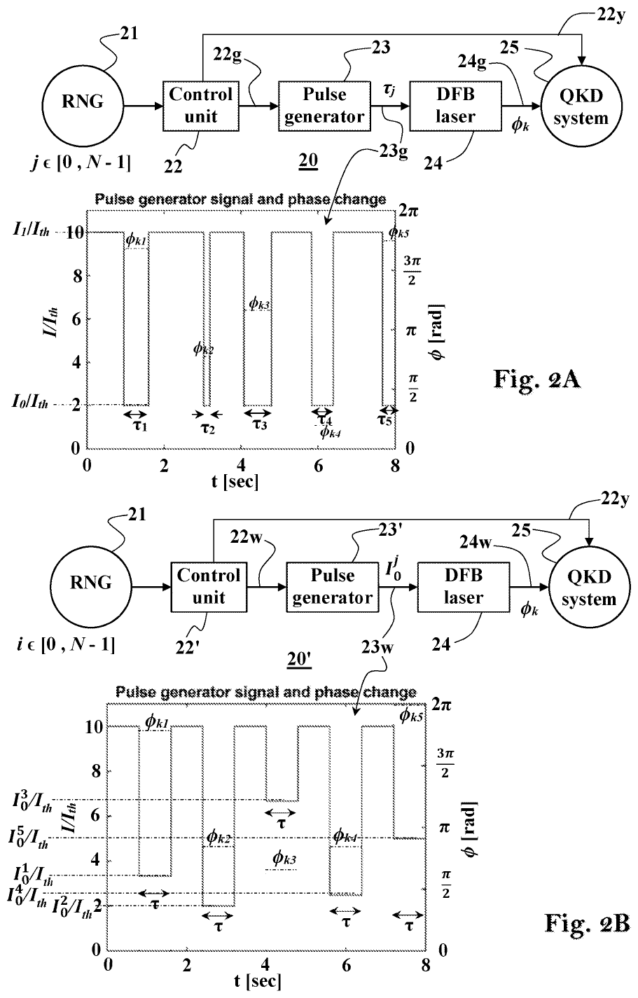

For each time interval τⱼ between consecutive working regimes w1, w2, w3, . . . , a phase change value φₖⱼ is selected in some embodiments by a random-number generator (RNG) configured to generate a random value j between 0 and N−1 (where j≥0 and N>1 are integer numbers). The random phase values φₖⱼ can be accordingly determined from the randomly drawn j values. The optical phase accumulated by the laser light source (e.g., 24 in FIGS. 2A and 2B) can be then changed by a physically controlled signal/pulse generator (e.g., 23) configured to drive the laser light source by either changing the level(s) of the idle injection current

$${I}_{0}^{j}$$

supplied to the laser light source between the working regimes w1, w2, w3, . . . to cause the desired phase change φₖⱼ, or by changing the durations of the time intervals τⱼ between the working regimes w1, w2, w3, . . . , to cause the desired phase change, or by changing both the idle injection current

$${I}_{0}^{j}$$

and the time durations of the intervals τⱼ between the working regimes w1, w2, w3, . . . .

A system 20 for application of random phase changes ϕₖᵢ between consecutive working regimes w1, w2, w3, . . . of data transmission pulses of an optical transmitter according to possible embodiments is illustrated in FIG. 2A. In this non-limiting example, the power/current supply driving a (e.g., DFB, Fabry Perot) semiconductor laser light source 24 is directly modulated by an external electric modulation signal 23g generated by a signal/pulse generator unit 23. The signal/pulse generator unit 23 is implemented in some embodiments by a programmable pulse generator, or by a specifically programmed controller driver e.g., implemented in a field-programable gate array (FPGA) and other electronic components, such as amplifiers, attenuators and combiners.

The operation of the signal/pulse generator unit 23 is controlled in this example by a control unit 22. The control unit 22 is configured in this non-limiting example to adjust the power (e.g., electric voltages and/or currents) supply patterns/signals driving the laser light source 24 to cause random phase changes as exemplified in FIG. 1A, by randomly altering the time intervals/gaps τⱼ between the consecutive working regimes w1, w2, w3, . . . . In some embodiments the random phase changes ϕₖⱼ between the consecutive working regimes w1, w2, w3, . . . is set by a random-number-generator (RNG) unit 21 (e.g., implemented by integrated circuitries configured to generate random bit streams by high-entropy physical processes) e.g., configured to generate random integer numbers 0≤j≤N−1 within a range corresponding to a number of random phase changes desired in the system 20.

The control unit 22 is configured to receive the random integer numbers j generated by the RNG unit 21, and determine for each of the randomly generated integer numbers j a corresponding time interval/gap τⱼ (e.g., using a lookup table) for the idle power supply signals. The control unit 22 then generates control signals 22g configured to operate the signal/pulse generator 23 thereby producing the power supply signals 23g driving the laser light source 24 with the determined time interval durations τⱼ between the consecutive working regimes w1, w2, w3, . . . . This way, each phase change ϕⱼ that is affected by the control unit 22 is randomly picked from a predefined range of phase change values φₖ₀, φₖ₁, . . . φ_{N-1} e.g., from at least 10 uniformly distributed phase values ϕⱼ∈[0,2π); N=9.

The control signals 22g generated by the control unit 22 can be further configured to set the working supply signal power (e.g., electric current I₁) used for the working regimes w1, w2, w3, . . . by the laser light source 24, which in this non-limiting example is set to a fixed predefined level (e.g., I₁/Iₜₕ=10, which is not necessarily a whole number), and the idle supply power (e.g., electric current I₀) which is set to a smaller fixed predefined level (e.g., I₀/Iₜₕ=2, which is also not necessarily a whole number), which is always distinctly greater than the lasing threshold (Iₜₕ) of the laser light source 24. The signal/pulse generator 23 can be however configured to generate power supply pulses/signals (e.g., electric voltage and/current) to the laser light source 24 with fixed predefined working (e.g., I₁) and idle (e.g., I₀) supply power levels, and only adjust the durations of the time interval/gap τⱼ between the consecutive working regimes w1, w2, w3, . . . based on the control data/signals 22g received from the control unit 22.

The laser light pulses 24g generated by the laser light source 24 can be used by an optical communication transmitter (e.g., QKD system) 25 to encode data (e.g., using an electro-optical modulator) and optically transmit the same to one or more receiver systems (not shown). The control unit 22 is thus configured in some embodiments to generate synchronization signals 22y used to synchronize between different building blocks of the (e.g., QKD) communication system and indicate to the optical communication transmitter 25 the beginning and ending of each of the working regimes w1, w2, w3, . . . of the system 20 for it to encode the data onto the emitted laser light, and ignore the light/radiation produced by the system 20 during the time intervals τ₁, τ₂, τ₃, . . . during which the laser light source 24 is driven by the idle supply signals (e.g., I₀).

FIG. 2B schematically illustrates a system 20′ for application of random phase changes ϕₖᵢ between consecutive working regimes w1, w2, w3, . . . of data transmission pulses according to possible embodiments. In this non-limiting example the power supply patterns/signals (e.g., electric voltages and/or currents) driving the (e.g., DFB, Fabry Perot) semiconductor laser light source 24 are directly modulated by an external electric modulation signal 23w generated by a signal/pulse generator unit 23′ and configured to alter the wavelength λⱼ of the light/radiation emitted by the laser light source 24 between the working regimes w1, w2, w3, . . . The signal/pulse generator unit 23′ can be similarly implemented by a programmable pulse generator, or by a specifically programmed controller driver e.g., implemented in a field-programable gate array (FPGA).

The system 20′ of FIG. 2B is substantially similar to the system 20 of FIG. 2A, and thus same reference numerals are used therein to designate similar components. The control unit 22′ of the system 20′ is configured to control the operation of the signal/pulse generator 23′ to randomly adjust the levels of the idle supply signal (e.g., current

$${I}_{0}^{j} )$$

supplied to the laser light source 24, to thereby alter the wavelength λⱼ of the light/radiation emitted by the laser light source 24 between the working regimes w1, w2, w3, . . . , and correspondingly cause random phase changes change ϕⱼ between the working regimes w1, w2, w3, . . . .

A RNG 21 can be similarly used to generate random integer numbers 0≤j≤N−1 within the range corresponding to the number of random phase changes desired in the system 20, which are used by the control unit 22′ to determine based thereon (e.g., using a lookup table) a corresponding idle supply signals (e.g., current

$${I}_{0}^{j} )$$

for driving the signal/pulse generator 23′. The control unit 22′ can accordingly generate the control data/signals 22w, used for operating the signal/pulse generator 23′, based on the random integer numbers j generated by the RNG 21, to accordingly produce random idle power supply signals (e.g., current) levels 23w for driving the laser light source 24 between the working regimes w1, w2, w3, . . . The control data/signals 22w generated by the control unit 22′ can be similarly configured to set the working supply power signal (e.g., electric current I₁) used for generating the laser light of the working regimes w1, w2, w3, . . . by the laser light source 24, which in this non-limiting example is set to a fixed predefined level (e.g., I₁/Iₜₕ=10, which is not necessarily a whole number).

This way, the laser light source 24 is powered between the consecutive working regimes w1, w2, w3, . . . by random idle supply signals

$$( i . e . , {I}_{0}^{j} ) .$$

In this non-limiting example a fixed time interval/gap τ is maintained between the working regimes w1, w2, w3, . . . , but in possible embodiments it may be also varied, if so required. The signal/pulse generator 23′ can be accordingly configured to generate the supply signals with fixed/defined working and idle time intervals and fixed/defined working supply (I₁), and randomly set the power/levels of the idle supply signals

$$( i . e . , {I}_{0}^{j} )$$

based on the control signals 23w received from the control unit 22′.

The laser light pulses 24w generated by the laser light source 24 can be similarly used by an optical communication transmitter (e.g., QKD system) 25 to encode data (e.g., using an electro-optical modulator) and optically transmit the same to one or more receiver systems (not sown). The control unit 22′ can be similarly configured to generate the synchronization signals 22y used to synchronize between different building blocks of the (e.g., QKD) communication system and indicate to the optical communication transmitter 25 the beginning and ending of each of the working regimes w1, w2, w3, . . . of the system 20 for encoding the data onto the laser light produced by the laser light source 24, and ignoring the light/radiation produced by the system 20′ due to the idle supply signals

$${I}_{0}^{1} , {I}_{0}^{2} , {I}_{0}^{3} , …$$

It is noted that though FIGS. 2A and 2B exemplify use of semiconductor laser light source, such a DFB or, Fabry Perot laser, in possible embodiments other types of laser light sources can be similarly contemplated. FIG. 2C demonstrates a uniform division of the phase range (2π) into N phase segments or phase values φ₁, φ₂, φ₃, . . . , φ_{N}, according to possible embodiments. in this specific and non-limiting example the phase range is divided into N=10 phase segments usable to implement QKD protocols utilizing decoy states, as also exemplified in FIGS. 2A and 2B, from which the phase changes ϕⱼ between the consecutive working regimes w1, w2, w3, . . . are randomly selected. It is however noted that in possible embodiment the phase segments φ₁, φ₂, φ₃, . . . , φ_{N}, are not necessarily evenly distributed as exemplified in FIG. 2C.

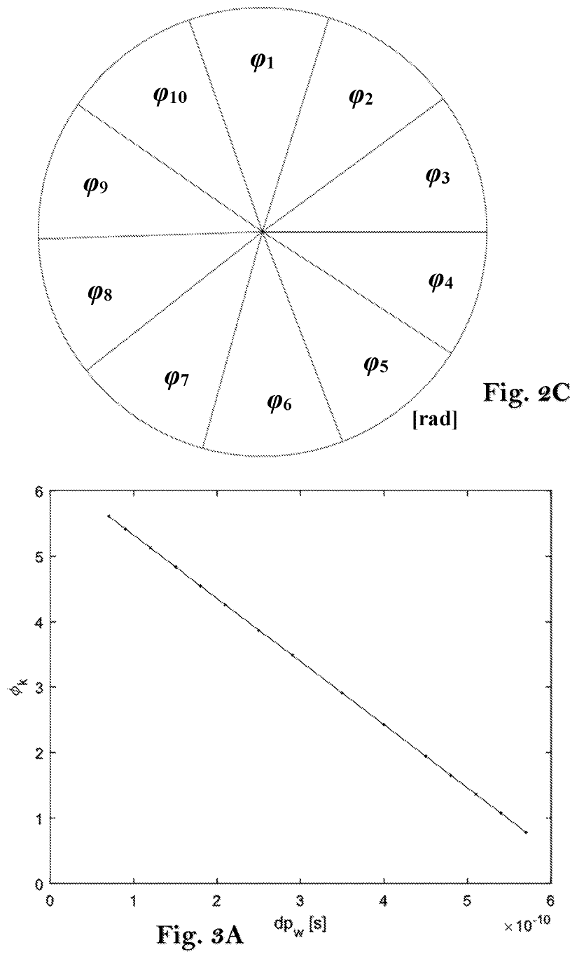

Experimental demonstration of feasibility of such embodiments is shown in FIGS. 3A and 3B. In this experiment a coherent semiconductor distributed-feedback (DFB) laser light source, having a wavelength λ=1546.10±0.01 nm, with a coherence length L_{c} was directly modulated with a repetition rate of R=80.0±0.1 MHz and a pulse width of p_{w}=9.000±0.001 ns. The modulated light from the laser was injected into a fibered unbalanced Michelson interferometer. The difference between the arms of the interferometer was set to ΔL=0.10±0.01 m, so two consecutive pulses interfere on the beam-splitter, and ΔL<L_{c}. The output of the interferometer was directed to a fast photodiode and monitored on an oscilloscope.

Constructive interference visibility V dependence on spontaneous thermal variation of the interferometer was observed, with values V∈[0,1] and thermal phase variation of 2π for a period larger than 60 sec. As the thermal change is very slow compared to a controlled rapid phase change, the dependence

$$V = \frac{1 + cos ( {ω}_{T} t + {ϕ}_{k} )}{2}$$

is dominant by discrete phase control. This was achieved by changing the pulse width dp_{w} as displayed in FIGS. 3A and 3B. The intensity of the measured detector exhibits a transformation from perfect constructive to perfect destructive interference. As seen, the phase (ϕₖ) is adjusted in direct correspondence with the pulse width changes (dp_{w}). This demonstrates the continuous control of the relative phase between the two working/idle (‘on/off’) regimes and demonstrates the applicability of our method.

Controlling the time intervals (gap widths) τₖⱼ between the consecutive working regimes w1, w2, w3, . . . , as described hereinabove, has the advantage of being simpler for implementation in digital systems, as only two different voltage levels are required for the ‘on’/working and ‘off/idle regimes. Controlling the depth (i.e., the supply signals 23g e.g., idle currents

$${I}_{0}^{j} )$$

of the gaps between the consecutive working regimes w1, w2, w3, . . . can be achieved, for example, by combining fast switched and pulse-width-modulation (PWM) techniques, or by pulse-amplitude modulation (e.g., PAM16), or by driving a fast switch between voltage/current sources.

Alternatively, in some embodiments the different idle supply (e.g., currents

$${I}_{0}^{j} )$$

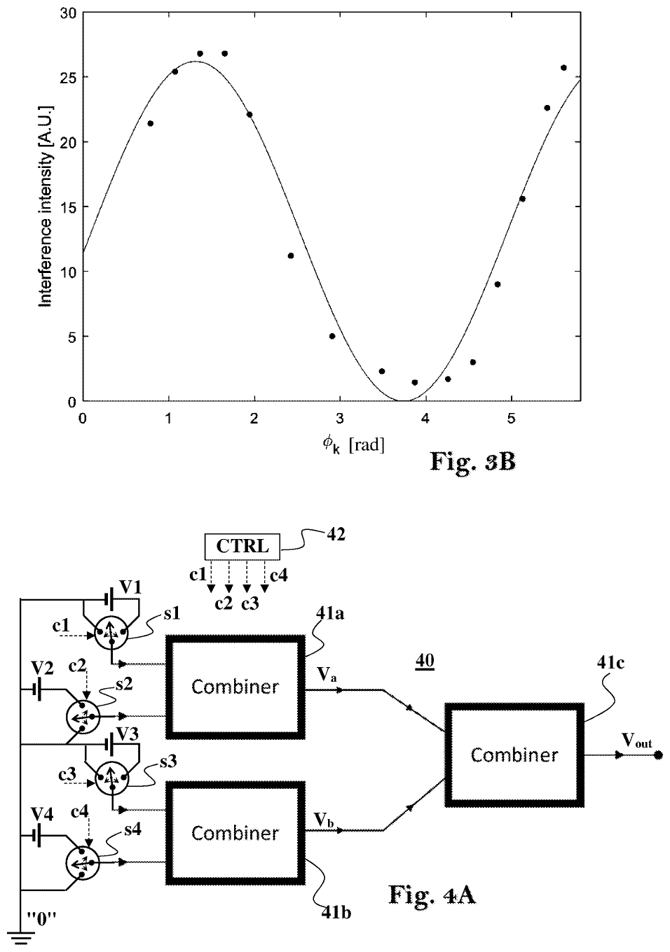

signals are implemented by a linear combination of few digital outputs c1, c2, . . . with respective different voltage levels V1, V2, . . . , as exemplified in FIGS. 4A and 4B. In this example, controllable switches s1, s2, . . . and analog combiner circuitries 41a, 41b and 41c (collectively referred to herein as combiners 41), are used to output a desired output voltage Vₒᵤₜ based on the control signals c1, c2, . . . generated by control unit 42.

Particularly, the control signals cᵢ(i=1, 2, 3, 4) generated by the control unit 42 are used by the switches si to set (by selecting between the ground/“0” and the Vi voltages) the voltage signals on the input terminals of the input combiners 41a and 41b, and the combined voltages Vₐ and V_{b} generated by the input combiners 41a and 41b are combined by the output combiner 41c that generates the output voltage Vₒᵤₜ. For example, in possible embodiments four (4) input voltage levels Vi can be used e.g., of V1=4 mV, V2=8 mV, V3=16 mV, V4=32 mV, and the three (3) combiners 41 are analog combiners with 3 dB loss (i.e., exhibiting 50% voltage reduction on the combiners' outputs), which can be thus used to provide sixteen (16) different voltage levels at the output Vₒᵤₜ by settings of the control signals ci e.g., 0 mV, 1 mV, 2 mV, 3 mV, 4 mV, 5 mV, 6 mV, 7 mV, 8 mV, 9 mV, 10 mV, 11 mV, 12 mV, 13 mV, 14 mV, 15 mV. FIG. 4B exemplifies generation of a 14 mV output by setting the control signal c1 to select the ground terminal (“0” volts) of switch s1, control signal c2 to select the V2 terminal (8 mV) of switch s2, control signal c3 to select the V3 terminal (12 mV) of switch s3, control signal c4 to select the V4 terminal (16 mV) of switch s4.

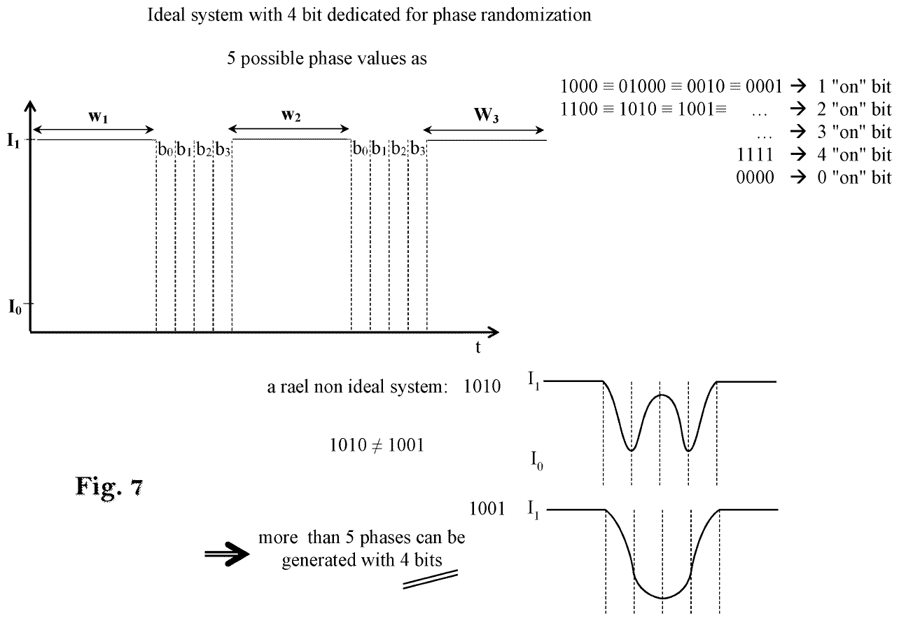

Another improvement that can be achieved is by applying an electric analog filter onto a digital modulation signal, switching at a higher modulation rate (for example 10 times the rate) than supported by the pulse generation circuit or by the laser bandwidth for example. The faster digital modulation signal can be used to modulate four (4) or more bits as idle signal levels between working intervals. As shown in FIG. 7, using two digital level output combinations, for example binary sequences ‘0101’ and ‘0011’, due to finite rise and fall time of signals, would result in different waveforms over current and time, and therefore different phase lag value. This allows shorter idle time for phase randomization and increased system bit rate, while keeping the necessary randomization between pulses.

A different number of bits can also be used, in order to achieve the desired number of distinct phase lag values, with an even distribution. Such high modulation bits can be generated by SERDES outputs of a fast FPGA, driving the current driver.

Another method to randomize the phase applied to the optical signal can be implemented by using electrical components in the laser modulation and pulse generation circuit that have an internal jitter and will introduce random phase shifts, by adding jitter to the modulation pulse rise and/or fall time. The added jitter randomizes the duration of the idle period. With a large enough difference between I₀ and I₁ the total randomly accumulated phase can be more than 2pi, which is the minimal required range. These are sufficient or accumulated for attributing to discrete phase randomization embodiments disclosed herein.

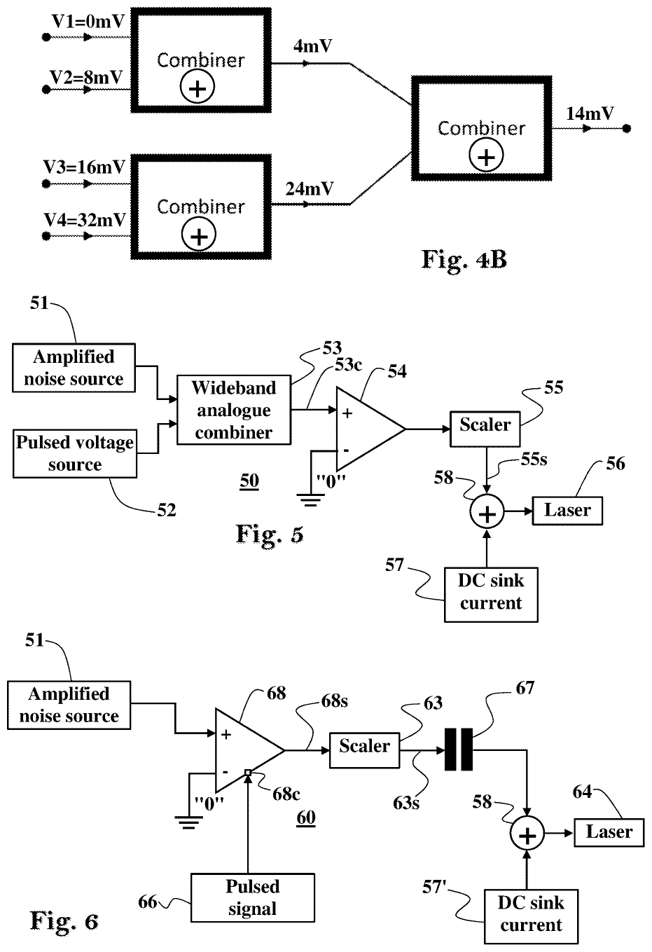

FIGS. 5 and 6 schematically illustrate noise driven laser systems 50 and 60 using a noise source to randomly form modulation patterns in which the idle supply (e.g., currents I₀) signals differ from the working supply (e.g., currents I₁) signal, for phase randomization between the working regimes (w1, w2, w3 . . . ). In these embodiments, in order to introduce a random phase (ϕₖ) of the optical output of the laser light source 56, supply signals driving the laser light source 56 are randomly modulate during the time windows between the relevant transmission windows of quantum data bits (i.e., between the working regimes w1, w2, w3, . . . ). In order to avoid the complexity of generating sufficiently random bits by an RNG (or algorithm), a noise source 51 is used in order to trigger a comparator 54 randomly between its ‘HIGH’ and ‘LOW’ states, which in turn modulates the supply signal of the laser light source 54 relative to its default bias drive current 57.

A possible implementation of the (amplified) noise source 51 in some embodiments utilizes a type of semiconductor avalanche noise generator e.g., a type of Zener-diode based noise generator. The noise source 51 is feeding an (wideband) analog combiner 53 configured to combine/summate the noise signals with (e.g., voltage) pulse signals generated by a signal/pulse generator 52, which are used to define the working regimes (w1, w2, w3, . . . ) of the data transmissions. The combined signals 53c generated by the analog combiner 53 feeds a comparator circuit 54) configured to generate a HIGH output signal whenever the combined signal 53c is greater than zero (“0” Volts), or a LOW output signal whenever the combined signal 53c is smaller than zero. The output of the comparator 54 can be then scaled by a scaler unit 55 in order to adjust its HIGH/LOW output signals to the desired modulation depth. The scaled signal 55s is then combined with a DC current sink 57 by an analog combiner unit 58 to drive the laser light source 56.

The output signal of the combiner unit 58 can this way provide the desired pulse width and repetition rate for driving the laser light source 56 for generating transmission laser light pulses for the working regimes of the transmitter (e.g., for quantum bits encoding in a later stage), while affecting random phase changes between these working regimes.

More particularly, when the output of the signal/pulse source 52 is HIGH (i.e., time windows w1, w2, w3 . . . ), the output of the combiner 53 will always be above the comparator threshold level (“0”), and the comparator 54 will output HIGH state (alternatively the complementary output can be used and a LOW output would result from the comparator). The comparator's output is then scaled by the scaler unit 55, and summed with the DC current from the sink current unit 57 to drive the laser source 56 at a pre-determined “working state” current. However, when the output from the signal/pulse source 52 is LOW, there is no contribution to the comparator input aside from the noise from the noise generator 51. The comparator threshold is accordingly set such that the noise signal at the comparator output randomly triggers the comparator 54 at a random frequency or duration. This way, the drive current supplied to the laser light source 56 will vary between the “working” and “idle” levels at random frequency or duration when the output from the signal/pulse source 52 is LOW, thereby creating random modulation of the laser current and power and randomly changing the phase between the working regimes (w1, w2, w3, . . . ).

The frequency spectrum of the noise is wide enough such that transitions are highly probable in each time window between the relevant transmission windows/regimes (w1, w2, w3, . . . ) of quantum data bits, such that the phase change will be random for each window of transmission of quantum bits.

An alternative embodiment is shown in FIG. 6, wherein the noise generator 51 triggers a latched-comparator 68 with threshold signals from the signal/pulse generator 66, so that the comparator triggers HIGH or LOW states at a random frequency or duration creating random modulation of the supply (e.g., current) signal and power of the laser light source 64, thereby randomly changing the phase of the laser light thereby emitted. In this embodiment the noise generator 51 (e.g., a Zener-diode based noise generator), is feeding the comparator 68, whose output 68s is scaled by the scaler 63 unit in order to generate the desired modulation depth. The scaled signal 63s from the scaler unit 63 is AC coupled (via an AC coupling circuitry e.g., using one or more capacitive elements) 67 to the analog combiner 58 for summation with the DC sink current 57′, (the DC sink current biases the laser to the desired working drive current) to drive the laser light source 64.

As seen, the comparator 68 has a latch input 68c, and it is latched by the pulsed signal from the signal/pulse generator 66, which is synchronised to the working windows/regimes (w1, w2, w3, . . . ) of transmission (e.g., of quantum bits). When the output of the signal/pulse source 66 is in the HIGH state (i.e., during the working windows/regimes w1, w2, w3, . . . ), the comparator 68 is latched so that the comparator output will not transition between states, and due to the AC coupling 67 will therefore not affect the DC bias level produced by the DC sink source 57′, which is the desired current level for the data (e.g., quantum bit) transmission windows/regimes.

This way, the drive current to the laser light source 64 is maintained constant and well defined during the data (e.g., quantum bit) transmission windows/regimes. During the time periods between said working windows/regimes, the supply (e.g., current) signals driving the laser light source 64 is varied at a random frequency or duration, thereby creating random modulation of the laser drive current above and below the nominal working drive current and randomly changing the phase between the working windows/regimes (w1, w2, w3, . . . ). In another embodiment the AC coupled signal may be clamped to always shift above or below the nominal working drive current. The scaler 63 is configured to adjust the amplitude of this modulation to be set as required for the operation of the laser light source 64. Optionally, but in some embodiments preferably, the frequency spectrum of the noise generated by the noise source 51 is wide enough such that transitions are highly probable in each time window between the relevant data transmission windows (e.g., of quantum data bits), and the phase change will thus be random for each window of data transmission.

The DC sink current source 57 in FIG. 5 is configured to produce a DC sink current that can be slightly greater than the lasing threshold current of the laser light source 64, to thereby guarantee that the supply signal (i.e., the of the DC sink current and the electric current generated by the scaler 63) driving the laser light source 64 is always greater than the lasing threshold for continuous and uninterrupted light transmission. The DC sink current source 57′ of FIG. 6 is however set to a higher level, to act as the working level, and as it may be modulated by the signal from the scaler into higher and lower levels.

It is noted that in possible embodiment the required phase randomization range can be greater than 2π, but the modulus of the whole range should have a uniform distribution over 2π. It is further noted that though the division of the 2π phase range into ten (10) phase segments is demonstrated herein, the 2π phase range is divided in some embodiments into more than 10 phase segments (e.g., 12, 16, . . . ), while a continuum of phase values is considered to be ideal (not discrete phases).

The present disclosure provides techniques to simplify phase randomization between consecutive data communication pulses, as required for QKD systems. In QKD systems, these techniques improve the efficiency of the QKD process as the disclosed phase randomization can take less time, allowing the increase of qubit transmission rate, and consume less random numbers from the RNG, as entropy is extracted from alternative noise sources. In addition, as shown by experimental results, these techniques could further simplify the setup by setting specific qubit states, and can be used for phase coding in classical communication. Additional uses the embodiments disclosed herein can be in the setting of the phase between the qubit states |0 [symbol] +e^{iϕ}|1 [symbol] , thus removing the need for additional phase modulators for state setting. This would be done by creating a phase difference in the ‘on’ regime of the current.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, microcode, etc.) or an embodiment combining software and hardware aspects that may generally be referred to herein as a “system.” Furthermore, the present invention may take the form of a computer program product on a computer-usable storage medium having computer-usable program code embodied in the medium. In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In another embodiment, features of the invention are implemented primarily in hardware using, for example, hardware components such as application specific integrated circuits (ASICs) or field-programmable gated arrays (FPGAs). Implementation of the hardware state machine so as to perform the functions described herein will be apparent to persons skilled in the relevant art(s). In yet another embodiment, features of the invention can be implemented using a combination of both hardware and software. The software which implements many aspects of the invention can be stored on a media. The media can be magnetic such as diskette, tape or fixed disk, or optical such as a CD-ROM. Additionally, the software can be supplied via the Internet or some type of private data network.

As described hereinabove and shown in the associated figures, the present invention provides phase randomization setups for optical communication and quantum applications, and related methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A control system for controlling light/radiation emitted from a laser light source, the system comprising a signal generator configured to controllably generate supply signals driving said laser light source and a control unit configured to generate control signals for controlling the operation of said signal generator for thereby generating a fixed predefined working supply signal driving said laser light source during time intervals in which the light/radiation thereby emitted is usable for data encoding, and variable idle supply signals driving said laser light source between said data encoding time intervals, said control signals configured to cause generation of the idle supply signals having at least one of the following: random time intervals and fixed idle supply signal level/intensity greater than a lasing threshold of said laser light source; and/or idle supply signal having random levels/intensities or randomly alternated levels/intensities greater than a lasing threshold of said laser light source, to thereby affect random phase changes between said data encoding time intervals without reducing the supply signal below said lasing threshold.

2. The control system of claim 1 wherein the control unit is configured to divide a phase range associated therewith into a predetermined number of phase segments, randomly select for each of the idle supply signals one of said predetermined number of phase segments, and generate the control signals such that the phase change affected by each of said idle supply signals is within the respective phase segment randomly therefor.

3. The control system of claim 2 wherein the control unit is configured to modulate the idle supply signal in accordance with a binary signal thereby selected from a plurality of binary signals to effect a phase change randomly chosen randomly chosen from a number of possible phase segments.

4. The control system of claim 2 comprising a random number generator (RNG), or a pseudo-RNG, and wherein the control unit is configured to use random numbers generated by said RNG or pseudo-RNG for the selection of phase segments for the idle supply signals.

5. The control system of claim 1 comprising discrete signal level generator configured to generate the idle supply signal by an analog combiners arrangement having controllably switched input signals, and wherein the control unit is configured to generate control signals for setting said controllably switched input signals in order to output a desired idle supply signal by said analog combiners.

6. The control system of claim 1 comprising a noise source configured to cause generation of the idle supply signals having randomly alternating signal levels.

7. The control system of claim 6 configured to cause generation of the idle supply signals having random signal length and time spacing.

8. The control system of claim 6 configured to cause generation of the idle supply signals having random signal length and time spacing and two discrete laser current drive levels.

9. The control system of claim 6 comprising a comparator configured to toggle between HIGH and LOW states thereof responsive to signals generated by the noise source.

10. The control system of claim 9 comprising a pulse signal source configured to hold the comparator in its HIGH states for time durations for generating the fixed predefined working supply signal of the laser light source.

11. The control system of claim 10 comprising an analog combiner configured to sum the signals from the noise source and the pulse signal source and drive an input terminal of the comparator.

12. The control system of claim 10 wherein the pulse signal source is configured to drive a latch input of the comparator.

13. The control system of claim 1 wherein the laser light source is configured to generate laser light/radiation for QKD data encoding, and wherein said control system is configured to generate synchronization signals indicative of working time intervals in which the fixed predefined working supply signals are generated.

14. A quantum communication transmitter comprising the control system of claim 1 and an electro-optical modulator configured to encode data into the light/radiation emitted by laser light source during working time intervals in which the fixed predefined working supply signals are generated.

15. The quantum communication transmitter of claim 14 configured to receive synchronization signals generated by the control system to indicate the working time intervals in which the fixed predefined working supply signals are generated, and encode the data by the electro-optical modulator based thereon.

16. A method for controlling light/radiation emitted from a laser light source for data communication, the method comprising modulating electric supply signals of a laser light source for generating a plurality of fixed predefined working supply signals configured to drive said laser light source during time intervals in which the light/radiation thereby emitted is encoded with data, and variable idle supply signals for driving said laser light source between said data encoding time intervals, said modulating comprising at least one of the following: generating the idle supply signals to include random time intervals and fixed idle supply signal level/intensity greater than a lasing threshold of said laser light source; and/or generating the idle supply signals to include idle supply signals having random levels/intensities or randomly alternated levels/intensities greater than a lasing threshold of said laser light source, to thereby affect random phase changes between said data encoding time intervals without reducing the supply signal below said lasing threshold.

17. The method of claim 16 comprising dividing a phase range into a predetermined number of phase segments, randomly selecting for each of the idle supply signals one of said predetermined number of phase segments, and generating the control signals such that the phase change affected by each of said idle supply signals is within the respective phase segment randomly therefor.

18. The method of claim 16 wherein the generating of the idle supply signal comprising controllably selecting one or more analog signals and combining them together to provide a desired idle supply signal.

19. The method of claim 16 comprising generating a noise signal and generating the idle supply by randomly alternating levels a supply signal in manner corresponding to said noise signal.

20. The method of claim 19 comprising toggling a comparator between HIGH and LOW states thereof in manner corresponding to the noise signal.

21. The method of claim 19 comprising latching the comparator with a pulse signal configured to define data encoding time intervals.

22. The method of claim 16 comprising generating synchronization signals indicative of working time intervals in which the fixed predefined working supply signals are generated.

23. The method of claim 16 comprising encoding quantum bit states into the light/radiation emitted by the laser light source during the data encoding time intervals.

24. The method of claim 23 comprising encoding QKD data into the light/radiation emitted by the laser light source during the data encoding time intervals.
